(19) United States
(12) Patent Application Publication
(10) Pub. No.: US 2013/0076223 A1
(43) Pub. Date: Mar. 28, 2013

(54) LED LAMP

(71) Applicant: Tsutomu TOTANI, Aichi (JP)

(72) Inventor: Tsutomu TOTANI, Aichi (JP)

(73) Assignee: Beat-Sonic Co., Ltd., Nisshin-shi (JP)

(21) Appl. No.: 13/607,873

(22) Filed: Sep. 10, 2012

(30) Foreign Application Priority Data
Sep. 28, 2011 (JP) P2011-211730

(51) Int. Cl. H05B 33/02

(52) U.S. Cl. 313/46

(57) ABSTRACT

An LED lamp includes a heat dissipator, a module substrate on which an LED chip is mounted and fixed to one end of the dissipater, a lighting circuit supplying electric power to the LED chip, and a light guide fixed to the dissipator so that a base of the light guide is located opposite the LED chip. Light emitted from the LED chip is incident on the light guide through its base, the incident light radiating out of a surface of the light guide to be diffused around the light guide. The lamp further includes a heat-conducting column projecting from the one end of the dissipator. The column has a distal end on which the substrate is disposed. The substrate and at least an outer periphery of the column are covered by the light guide. The outer periphery is located near the column surface on which the substrate is disposed.

### CROSS-REFERENCE TO RELATED APPLICATIONS

This application is based upon and claims the benefit of priority from the prior Japanese Patent Application No. 2011-211730 filed on Sep. 28, 2011, the entire contents of which are incorporated herein by reference.

### BACKGROUND

1. Technical Field

The present disclosure relates to an LED lamp incorporating an LED chip serving as a light source.

2. Related Art

Demand for LED lamps or LED light bulbs has recently been increasing as substitute for incandescent lamps having higher electrical power consumption. The LED lamps have far less power consumption. One type of LED lamp includes a metal heat dissipator made of a metal, such as aluminum, having high heat conductivity, a cap mounted on one end of the heat dissipator, a glove comprising a light-transmissive glass or plastic material having a semi-spherical top and attached to the other end of the heat dissipator, a module substrate on which an LED chip is mounted and a lighting circuit supplying electrical power to the LED chip. The module substrate is connected to one end of the heat dissipator, and the cap is attached to the other end of the heat dissipator. The lighting circuit is disposed in the heat dissipator, and the glove is mounted on the one end of the heat dissipator so as to cover the module substrate. The lighting circuit and the cap are electrically connected to each other.

Light emitted by a filament serving as a light source for an incandescent lamp is diffused around thereby to evenly illuminate the surrounding area. On the other hand, light emitted by the LED chip used as a light source for an LED lamp has a high directionality and accordingly has a characteristic of illuminating a frontward narrow region by intense light. In view of the characteristic, the LED lamp needs to be provided with a light diffusion unit which diffuses light emitted by the LED chip around the lamp in order that the LED lamp may be used as a substitute product for the incandescent lamp.

One type of LED lamp provided with the light diffusion unit has already been put into practical use. The light diffusion unit includes a light guiding member which has a reflection surface formed on a distal end thereof. The light guiding member is fixed to the heat dissipator so that a proximal end of the light guiding member is opposed to the LED chip. The glove is attached to the heat dissipator so as to cover the light guiding member.

According to the above-described type of LED lamp, light emitted by the LED chip goes into the light guiding member through the proximal end of the light guiding member to be guided to the reflection surface. The light is then reflected on the reflection surface to be diffused around the distal end of the light guiding member. The above-described type of LED lamp is disclosed by Japanese Patent Application Publication Nos. JP-A-2011-70972, JP-A-2011-82132, JP-A-2011-90828 and JP-A-2011-91033.

In the above-described type of LED lamp, light emitted from an upper surface of the LED chip is caught by the light guiding member thereby to be diffused around from the distal end of the light guiding member. Although large part of light generated by the LED chip is emitted from the upper surface thereof, the light is partially reflected diffusely on the outer periphery of the LED chip and the surface of the module substrate to be diffused around the LED chip.

The module substrate, the proximal end surface of the light guiding member and the end surface of the heat dissipator are substantially coplanar in the conventional LED lamp. Accordingly, the light is reflected diffusely on the outer periphery of the LED chip and the surface of the module substrate. The light diffused around the LED chip is difficult to catch by the light guiding member.

### SUMMARY

An object of the disclosure is to provide an LED lamp in which a larger amount of light can be caught by the light guiding member thereby to be diffused.

The present disclosure provides an LED lamp comprising a heat dissipator having two ends; a module substrate on which an LED chip is mounted, the module substrate being fixed to one end of the heat dissipator; a cap mounted on the other end of the heat dissipator; a lighting circuit supplying electric power to the LED chip and disposed in the heat dissipator, the lighting circuit being electrically connected to the cap; and a light guiding member fixed to the heat dissipator so that a base thereof is located opposite the LED chip, wherein light emitted from the LED chip is incident on the light guiding member through the base of the light guiding member, the incident light radiating out of a surface of the light guiding member to be diffused around the light guiding member, the LED lamp further comprising a heat-conducting column projecting from said one end of the heat dissipator, the heat-conducting column having a distal end on which the module plate is disposed, wherein the module substrate and at least an outer periphery of the heat-conducting column are covered by the light guiding member, said outer periphery being located near a surface of the heat-conducting column, on which surface the module substrate is disposed.

In the above-described configuration, heat produced by the LED chip transfers through the distal end of the heat-conducting column to the base of the heat dissipator thereby to be dissipated out of the heat dissipator. On the other hand, a large amount of light to be emitted from the LED chip is produced on an upper surface of the chip to be emitted from the upper surface, whereas part of the light diffusely reflects on an outer periphery of the LED chip and the surface of the module substrate thereby to diffuse around the LED chip.

The module substrate and at least an outer periphery of the heat-conducting column are covered by the light guiding member in the above-described configuration. In this case, the outer periphery is located near a surface of the heat-conducting column, on which surface the module substrate is disposed. Accordingly, the light diffusely reflecting on the outer periphery of the LED chip and the surface of the module substrate is caught by the light guiding member as well as the light emitted from the upper surface of the LED chip thereby to be diffused around the light guiding member from its surface. This can improve a light diffusion efficiency regarding the light emitted from the LED chip.

In one form, the light guiding member is formed substantially into a spherical shape and has a notch located at a top of the light guiding member and formed into an inverted polygonal pyramid shape so that the notch is located opposite the LED chip. Since the light emitted from the LED chip reflects on surfaces constituting the notch formed into the inverted polygonal pyramid shape thereby to be diffused, the light diffusion efficiency can further be improved.

In another form, the light guiding member is formed substantially into a flat spherical shape and has a top formed with a dish-shaped notch so that the notch is located opposite the LED chip. Since the light emitted from the LED chip reflects on a curved surface constituting the dish-shaped notch thereby to be diffused, the light diffusion efficiency can further be improved.

### BRIEF DESCRIPTION OF THE DRAWINGS

In the accompanying drawings:

FIG. 1 is a sectional view of an LED lamp according to a first embodiment;

FIG. 2 is a perspective view of the LED lamp with a glove and a light guiding member being eliminated;

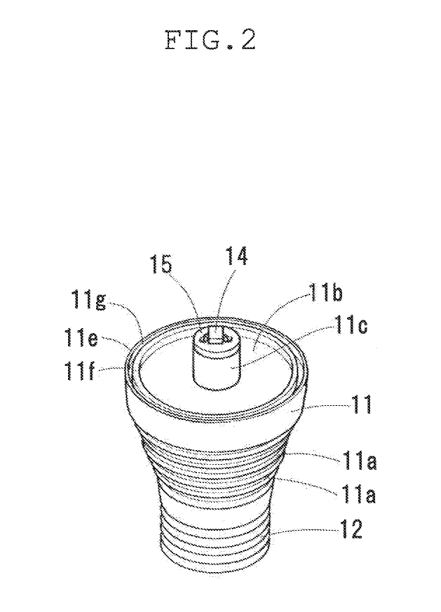

FIG. 3 is a perspective view of the light guiding member;

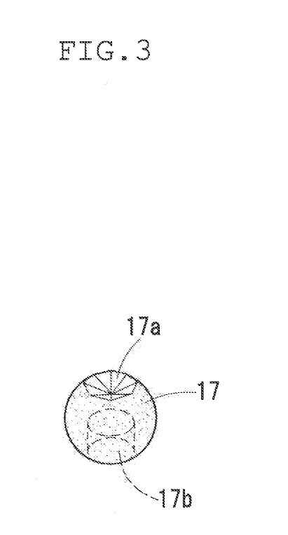

FIG. 4 is a sectional view of the LED lamp according to a second embodiment;

FIG. 5 is a perspective view of the light guiding member in the second embodiment; and

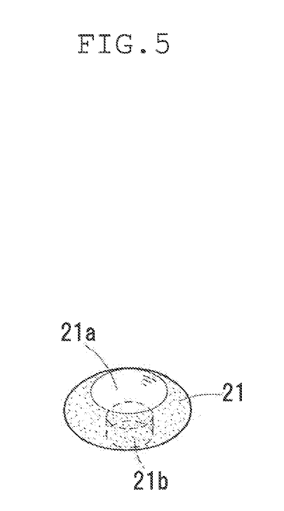

FIG. 6 is a sectional view of the LED lamp according to a third embodiment.

### DETAILED DESCRIPTION

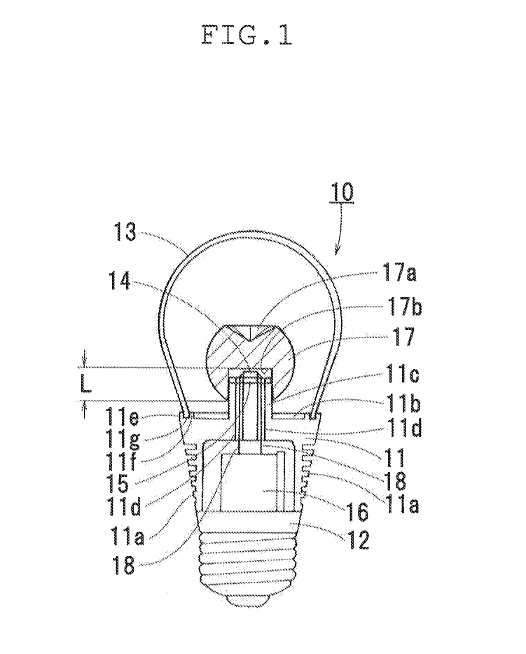

Several embodiments will be described with reference to the accompanying drawings. Referring to FIG. 1, an LED lamp 10 according to a first embodiment is shown. The LED lamp 10 includes a heat dissipator 11, a cap 12, a transparent glove 13, a module substrate 15 on which an LED chip 14 is mounted, a lighting circuit 16 supplying electric power to the LED chip 14 and a light guiding member 17.

The heat dissipator 11 is made of a metal, such as aluminum having a high heat conductivity and a high heat dissipation performance. The heat dissipator 11 has a cylindrical structure and is formed into the shape of a generally inverted truncated cone. The heat dissipator 11 has a large number of fins 11a which are formed on an outer periphery thereof so as to increase a surface area for improvement of the heat dissipation effect.

The heat dissipator 11 has an upper end 11b including a central part from which a cylindrical heat-conducting column 11c projects. The heat conducting column 11c has a distal end to which the module substrate 15 is fixed. The lighting circuit 16 is incorporated in the heat dissipator 11, and the module substrate 15 and the lighting circuit 16 are connected to each other by a lead wire 18. The lead wire 18 is inserted through a through hole lid which extends from the distal end of the heat-conducting column 11c to a back side of an upper end of the heat dissipator 11. The cap 12 is mounted to a lower end of the heat dissipator 11 and has a shape and dimensions according to the International Standard. The lighting circuit 16 and the cap 12 are electrically connected to each other by a lead wire (not shown).

The light guiding member 17 is a resin mold such as acrylic and has a solid structure. The light guiding member 17 is formed substantially into a spherical shape. The light guiding member 17 includes a top formed with a notch 17a having a generally inverted polygonal pyramid shape. The light guiding member 17 has a base formed with a recess 17b. The light guiding member 17 has a surface which is pearskin finished and is secured to the heat-conducting column 11c by an adhesive agent with the recess 17b into which the distal end of the heat-conducting column 11c is fitted. The light guiding member 17 is disposed so that the notch 17a is located opposite the LED chip 14 when the recess 17b is fitted with the heat-conducting column 11c.

The recess 17b has a depth L that is set so that the light guiding member 17 covers not only the module substrate 15 but also at least a part of the outer periphery of the heat-conducting column 11c, which part of the outer periphery is located near the surface of the heat-conducting column 11c. The module substrate 15 is disposed on the surface of the heat-conducting column 11c. As a result, the base of the light guiding member 17 reaches a middle part of the heat-conducting column 11c.

The heat dissipator 11 has an upper end 11b formed with two, inner and outer, annular convex portions 11e and 11f. A ring groove 11g is defined by the annular convex portions 11e and 11f. The glove 13 has a hollow structure and is formed with a lower end opening. The glove 13 is secured to the upper end 11b of the heat dissipator 11 by an adhesive agent while the lower end opening of the glove 13 is fitted with the ring groove 11g. The light guiding member 17 is covered by the glove 13.

In the LED lamp 10 configured as described above, heat generated by the LED chip 14 transfers from the distal end of the heat-conducting column 11c through the heat-conducting column 11c to the body of the heat dissipator 11 to be dissipated out of the LED lamp 10.

A large amount of light emitted from the LED chip 14 is produced on an upper surface of the chip. The light goes from the upper surface of the chip into the light guiding member 17 and is they reflected on the faces constituting the notch 17a of the inverted polygonal pyramid shape to be diffused as the light exits through the pearskin finished surface of the light guiding member 17. A large amount of the light exiting through the pear skin finished surface passes through the glove 13 while part of the light is reflected on an inner surface of the light glove 13. Furthermore, part of the light going from the upper surface of the chip into the light guiding member 17 is reflected on an inner surface of the light guiding member 17. On the other hand, part of light emitted from the LED chip 14 is diffusely reflected on an outer periphery of the LED chip 14 and a surface of the module substrate 15, diffusing around the LED chip 14.

According to the LED lamp 10 of the first embodiment, the module substrate 15 is fixed to the distal end of the heat-conducting column 11c projecting from the upper and 11b of the heat dissipator 11. As a result, the light guiding member 17 is configured to be capable of covering not only the module substrate 15 but also at least a part of the outer periphery of the heat-conducting column 11c, which part of the outer periphery is located near the surface of the heat-conducting column 11c. The module substrate 15 is disposed on the surface of the heat-conducting column 11c. This configuration allows the light guiding member 17 to catch the light diffusely reflected on the outer periphery of the LED chip 14 and the surface of the module substrate 15 as well as the light emitted from the upper surface of the LED chip 14, whereupon the light caught by the light guiding member 17 can be diffused around the light guiding member 17 from the surface of the light guiding member 17. Furthermore, the light reflected on the inner surface of the glove 13 is diffusely reflected on the pearskin finished surface of the light guiding member 17. This can improve the light diffusion efficiency of the LED chip 14.

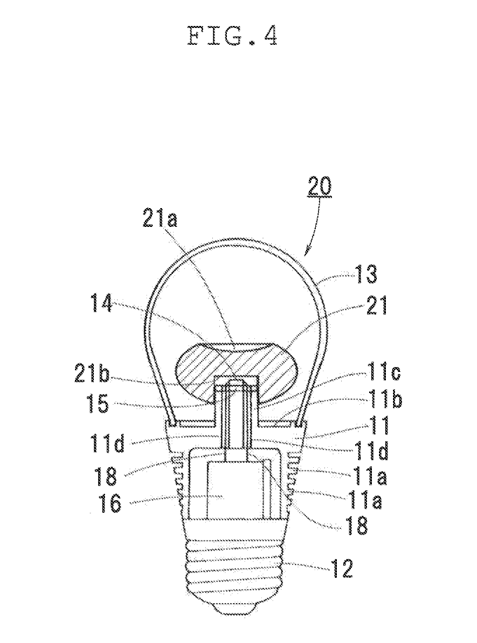

FIG. 4 illustrates the LED lamp 20 of a second embodiment. The LED lamp 20 includes a light guiding member 21 which has a solid structure and is formed into the shape of a generally flat sphere. The light guiding member 21 has a top formed with a dish-shaped notch 21a. The light guiding member 21 also has a base formed with a recess 21b in which the distal end of the heat-conducting column 11c is fitted. The surface of the light guiding member 21 is pearskin finished.

The other configuration of the LED lamp 20 is the same as that of the LED lamp 10 of the first embodiment. Accordingly, identical or similar parts in the second embodiment are labeled by the same reference symbols as those in the first embodiment, and the description of these parts will be eliminated.

Light emitted from the upper surface of the LED chip 14 and light reflected on the inner surface of the glove 13 are reflected on a curved surface constituting the dish-shaped notch 21a of the light guiding member 21 thereby to be diffused around the light guiding member 21.

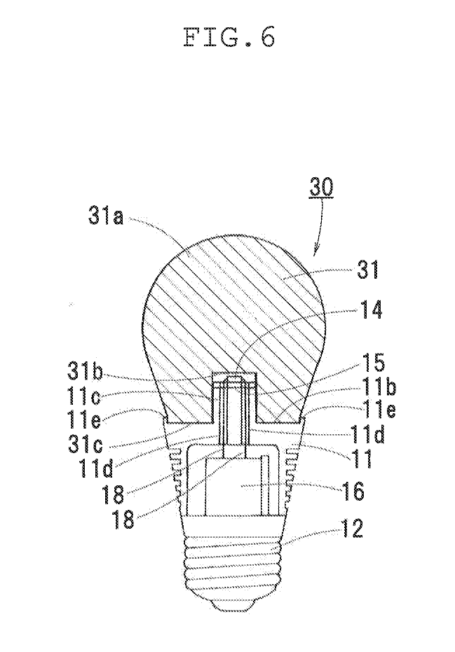

FIG. 6 illustrates the LED lamp 30 of a third embodiment. Each of the LED lamps 10 and 20 of the respective first and second embodiments has a shape similar to those of general incandescent lamps. In the third embodiment, however, the glove 13 is eliminated in the LED lamp 30, and the light guiding member 31 made of a resin is formed into such a predetermined shape as to provide a shape of the LED lamp 30 similar to those of the incandescent lamps.

The light guiding member 31 has a substantially semispherical top 31a and a proximal end formed with the recess 31b in which the heat-conducting column 11c is fitted. The recess 31b has such a predetermined depth as to cover the entire heat-conducting column 11c. Furthermore, the light guiding member 31 has a proximal end surface 31c which has an area sufficient to cover substantially the entire upper end surface 11b of the heat dissipator 11. The light guiding member 31 is fixed to the heat dissipator 11 by an adhesive agent while the heat-conducting column 11c is fitted in the recess 31b and the proximal end surface 31c is abutted against the upper end surface 11b of the heat dissipator 11.

The other configuration of the LED lamp 30 is the same as that of the LED lamp 10 of the first embodiment. Accordingly, identical or similar parts in the second embodiment are labeled by the same reference symbols as those in the first embodiment, and the description of these parts will be eliminated.

According to the LED lamp 30, the glove 13 which has a hollow structure and is accordingly easy to break is eliminated, and the light guiding member 31 having the solid structure is provided, instead. Consequently, the strength of the LED lamp 30 can be improved.

Although the cylindrical heat-conducting column 11c is provided on the LED lamps 10, 20 and 30 of the first to third embodiments respectively, the heat-conducting column may be formed into a prismatic or square column or a trapezoidal shape.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An LED lamp comprising:
a heat dissipator having two ends;
a module substrate on which an LED chip is mounted, the module substrate being fixed to one end of the heat dissipator;
a cap mounted on the other end of the heat dissipator:
a lighting circuit supplying electric power to the LED chip and disposed in the heat dissipator, the lighting circuit being electrically connected to the cap; and
a light guiding member fixed to the heat dissipator so that a base thereof is located opposite the LED chip,
wherein light emitted from the LED chip is incident on the light guiding member through the base of the light guiding member, the incident light radiating out of a surface of the light guiding member to be diffused around the light guiding member,
the LED lamp further comprising a heat-conducting column projecting from said one end of the heat dissipator, the heat-conducting column having a distal end on which the module plate is disposed,
wherein the module substrate and at least an outer periphery of the heat-conducting column are covered by the light guiding member, said outer periphery being located near a surface of the heat-conducting column, on which surface the module substrate is disposed.

2. The LED lamp according to claim 1, wherein the light guiding member is formed substantially into a spherical shape and has a notch located at a top of the light guiding member and formed into an inverted polygonal pyramid shape so that the notch is located opposite the LED chip.

3. The LED lamp according to claim 1, wherein the light guiding member is formed substantially into a flat spherical shape and has a top formed with a dish-shaped notch so that the notch is located opposite the LED chip.
